(19) United States
(12) Patent Application Publication
(10) Pub. No.: US 2025/0309805 A1
(43) Pub. Date: Oct. 2, 2025

(54) ROTARY MACHINE CONTROL DEVICE

(71) Applicant: Mitsubishi Electric Corporation, Chiyoda-ku, Tokyo (JP)

(72) Inventors: Kota TERAMOTO, Tokyo (JP); Toshiki SUZUKI, Tokyo (JP)

(73) Assignee: Mitsubishi Electric Corporation, Chiyoda-ku, Tokyo (JP)

(21) Appl. No.: 18/865,162

(22) PCT Filed: May 17, 2022
(86) PCT No.: PCT/JP2022/020584

§ 371 Date: Nov. 12, 2024

(51) Int. Cl. H02P 21/18; H02P 21/22

(52) U.S. Cl. CPC H02P 21/18; H02P 21/22

(57) ABSTRACT

A control device includes: a current detection unit that detects a rotary machine current flowing through a rotary machine; a position estimation unit that calculates an estimated value of a rotor position of a rotor on the basis of the rotary machine current; a current control unit that generates a first voltage command for driving the rotary machine on the basis of a detected rotary machine current and an estimated rotor position; a position-estimating voltage generation unit that generates a high-frequency voltage having a frequency higher than the first voltage command, and being a voltage for estimating the rotor position, on the basis of a torque-axis current command correlated with magnetic saturation of the rotor; and a voltage applier that applies a driving voltage to the rotary machine on the basis of a second voltage command in which the position-estimating voltage is superimposed on the first voltage command.

### FIELD

The present disclosure relates to a rotary machine control device that performs control by obtaining rotor position information without using a position sensor that detects a rotor position.

### BACKGROUND

In order to drive a rotary machine while fully utilizing performance of the rotary machine, position information of a rotor is necessary. Therefore, a rotary machine has been driven by using position information detected by a position sensor attached to the rotary machine. On the other hand, in recent years, a technique for performing position-sensorless driving of a rotary machine has been developed from the viewpoints of further reducing manufacturing cost of the rotary machine, reducing the size of the rotary machine, and improving the reliability of the rotary machine.

In position-sensorless control of a rotary machine, a method for estimating a rotor position of the rotary machine from an induced voltage of the rotary machine depending on a speed region and a method for estimating a rotor position of the rotary machine by using saliency are used in combination or separately. The former is used in a high-speed region in which an induced voltage necessary for position estimation can be sufficiently obtained, and the latter is used in a low-speed region in which a sufficient induced voltage cannot be obtained.

As a conventional technique for estimating a rotor position of a rotary machine using saliency as in the latter, for example, Patent Literature 1 below discloses a technique for superimposing a high-frequency voltage having a frequency higher than a fundamental frequency on a drive voltage and applying the superimposed voltage to a rotary machine. Specifically, in Patent Literature 1, a high-frequency current vector having an elliptical locus is separated into a positive-phase current vector and a mirror-phase current vector, and an intermediate angle between the two vectors is calculated, and thereby detecting a rotor position.

### CITATION LIST

### Patent Literature

Patent Literature 1: Japanese Patent Application Laid-open No. 2002-171799

### SUMMARY OF INVENTION

### Problem to be Solved by the Invention

However, even when the technique of Patent Literature 1 is used, in a case where a saliency ratio of the rotary machine is structurally small, the locus of the high-frequency current vector does not have a clear elliptical shape depending on a rotary machine current, and thus, there remains a problem that detection accuracy of the rotor position decreases.

The present disclosure has been made in view of the above, and an object thereof is to provide a rotary machine control device capable of reducing a decrease in detection accuracy of a rotor position even in a case where a saliency ratio of a rotary machine is structurally small.

### Means to Solve the Problem

In order to solve the above-described problem and achieve the object, a rotary machine control device according to the present disclosure includes a current detection unit, a position estimation unit, a current control unit, a position-estimating voltage generation unit, and a voltage applier. The current detection unit detects a rotary machine current flowing through a rotary machine. The position estimation unit calculates an estimated value of a rotor position that is position information of a rotor of the rotary machine on the basis of the rotary machine current. The current control unit generates a first voltage command that is a command value of a rotary machine voltage for driving the rotary machine on the basis of a detected value of the rotary machine current and an estimated value of the rotor position. The position-estimating voltage generation unit generates a high-frequency voltage having a frequency higher than the first voltage command, the high-frequency voltage being a position-estimating voltage for estimating the rotor position, on the basis of a physical quantity correlated with magnetic saturation of the rotor. The voltage applier applies a driving voltage to the rotary machine on the basis of a second voltage command in which the position-estimating voltage is superimposed on the first voltage command.

### Effects of the Invention

The rotary machine control device according to the present disclosure achieves an effect that it is possible to reduce a decrease in detection accuracy of a rotor position even in a case where a saliency ratio of a rotary machine is structurally small.

### BRIEF DESCRIPTION OF DRAWINGS

FIG. 1 is a diagram illustrating an exemplary configuration of a rotary machine control device according to a first embodiment.

FIG. 2 is a diagram illustrating examples of waveforms of high-frequency voltages output from a position-estimating voltage generation unit in FIG. 1.

FIG. 3 is a cross-sectional view used for explanation of a structure of a rotor core in a reluctance rotary machine assumed in the first embodiment.

FIG. 4 is a diagram illustrating a change in inductance in a general reluctance rotary machine.

FIG. 5 is a diagram illustrating examples of current vector loci when a high-frequency current is flowed through a rotary machine including the rotor core illustrated in FIG. 3.

FIG. 6 is a diagram illustrating, in the rotor core illustrated in FIG. 3, a flow of a magnetic flux generated by a component of a high-frequency current when a component of a fundamental current is small.

FIG. 7 is a diagram illustrating an example of a coefficient value table used in high-frequency boost control according to the first embodiment.

FIG. 8 is a first diagram for explaining an effect of the high-frequency boost control according to the first embodiment.

FIG. 9 is a second diagram for explaining the effect of the high-frequency boost control according to the first embodiment.

FIG. 10 is a diagram illustrating an exemplary configuration of a rotary machine control device according to a second embodiment.

FIG. 11 is a diagram illustrating a first exemplary hardware configuration that realizes functions of the control devices according to the first embodiment and the second embodiment.

FIG. 12 is a diagram illustrating a second exemplary hardware configuration that realizes the functions of the control devices according to the first embodiment and the second embodiment.

### DESCRIPTION OF EMBODIMENTS

Hereinafter, a rotary machine control device according to each embodiment of the present disclosure will be described in detail with reference to the accompanying drawings.

### First Embodiment

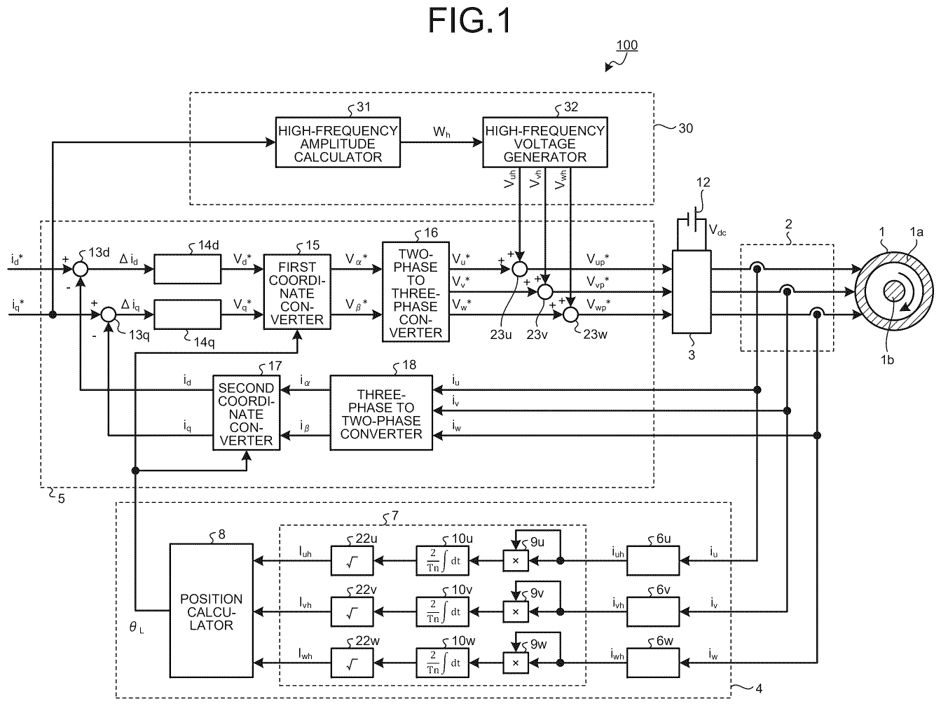

FIG. 1 is a diagram illustrating an exemplary configuration of a rotary machine control device (hereinafter, appropriately abbreviated as a “control device”) 100 according to a first embodiment. The control device 100 according to the first embodiment includes a current detection unit 2, a voltage applier 3, a position estimation unit 4, a current control unit 5, a direct-current power supply 12, and a position-estimating voltage generation unit 30. In FIG. 1, the current control unit 5 is a controller of a current control system, and the position estimation unit 4 and the position-estimating voltage generation unit 30 are controllers of a rotor position estimation system.

A rotary machine 1 is a device driven by the control device 100. The rotary machine 1 includes a stator 1a and a rotor 1b disposed inside the stator 1a. In this description, a reluctance rotary machine is assumed as an example of the rotary machine 1, but there is no limitation thereto. The rotary machine 1 may be, for example, an interior permanent magnet rotary machine.

The direct-current power supply 12 supplies direct-current power to the voltage applier 3. In a case where the rotary machine 1 is a motor, the voltage applier 3 generates an alternating-current voltage for driving the motor by using a direct-current voltage V_{dc} to be applied, and applies the generated alternating-current voltage to the motor.

The current detection unit 2 detects rotary machine currents iᵤ, iᵥ, and i_{w} flowing between the voltage applier 3 and the rotary machine 1. The rotary machine currents iᵤ, iᵥ, and i_{w} are stator currents flowing through each phase of the stator 1a, that is, a u phase, a v phase, and a w phase. A current detector is disposed in each phase of the current detection unit 2. An example of the current detector is a current transformer. In FIG. 1, the current detection unit 2 detects all of currents in three phase, but there is no limitation thereto. Currents of any two phases of the three phases may be detected, and a current of the remaining one phase may be obtained by calculation using the fact that the rotary machine currents iᵤ, iᵥ, and i_{w} are in three-phase equilibrium. Alternatively, instead of using the current detection unit 2 in FIG. 1, a bus current flowing through a direct-current bus that connects the voltage applier 3 and the direct-current power supply 12 may be detected, and the rotary machine currents iᵤ, iᵥ, and i_{w} may be obtained by calculation from the bus current.

The position estimation unit 4 calculates an estimated value θ_{L} of a rotor position which is position information of the rotor 1b on the basis of the rotary machine currents iᵤ, iᵥ, and i_{w}. The current control unit 5 generates first voltage commands Vᵤ*, Vᵥ*, and V_{w}* which are command values of rotary machine voltages for driving the rotary machine 1 on the basis of detected values of the rotary machine currents iᵤ, iᵥ, and i_{w} and the estimated value θ_{L} of the rotor position. The position-estimating voltage generation unit 30 generates high-frequency voltages Vᵤₕ, Vᵥₕ, and V_{wh} having higher frequencies than the first voltage commands Vᵤ*, Vᵥ*, and V_{w}* on the basis of a q-axis current command i_{q}*. The high-frequency voltages Vᵤₕ, Vᵥₕ, and V_{wh} are position-estimating voltages for estimating the rotor position. The current control unit 5 superimposes the high-frequency voltages Vᵤₕ, Vᵥₕ, and V_{wh} on the first voltage commands Vᵤ*, Vᵥ*, and V_{w}*, and outputs the superimposed voltages to the voltage applier 3 as second voltage commands Vᵤₚ*, Vᵥₚ*, and V_{wp}*. The voltage applier 3 generates driving voltages on the basis of the second voltage commands Vᵤₚ*, Vᵥₚ*, and V_{wp}*, and applies the driving voltages to the rotary machine 1. In this description, the voltage applier 3 is assumed to be a three-phase inverter with two levels, but is not limited thereto. In this description, the voltage applier 3 may be a three-phase inverter with three levels, or may be a multi-phase inverter with two levels or three levels.

The current control unit 5 includes subtractors 13d and 13q, a d-axis current controller 14d, a q-axis current controller 14q, a first coordinate converter 15, a two-phase to three-phase converter 16, a second coordinate converter 17, a three-phase to two-phase converter 18, and adders 23u, 23v, and 23w.

The subtractor 13d calculates a deviation Δi_{d} between a d-axis current command i_{d}* and a d-axis current i_{d} output from the second coordinate converter 17. The d-axis current controller 14d of the next stage performs proportional-integral control so that the deviation Δi_{d} becomes zero, and thereby calculating a d-axis voltage command V_{d}*. The subtractor 13q calculates a deviation Δi_{q} between the q-axis current command i_{q}* and a q-axis current i_{q} output from the second coordinate converter 17. The q-axis current controller 14q of the next stage performs proportional-integral control so that the deviation Δi_{q} becomes zero, and thereby calculating a q-axis voltage command V_{q}*. The d-axis current command i_{d}* is a command value of the d-axis current for driving the rotary machine 1, and the q-axis current command i_{q}* is a command value of the q-axis current for driving the rotary machine 1. Both the d-axis current command i_{d}* and the q-axis current command i_{q}* are provided from the outside of the current control unit 5.

The first coordinate converter 15 converts the d-axis voltage command V_{d}* and the q-axis voltage command V_{q}* respectively output from the d-axis current controller 14d and the q-axis current controller 14q into voltage commands V_{α}* and V_{β}* on static biaxial coordinates, respectively. The two-phase to three-phase converter 16 converts the voltage commands V_{α}* and V_{β}* output from the first coordinate converter 15 into first voltage commands Vᵤ*, Vᵥ*, and V_{w}* which are drive voltage commands of three-phase alternating-current coordinates. The estimated value θ_{L} of the rotor position output from the position estimation unit 4 is used for a process of the first coordinate converter 15.

The three-phase to two-phase converter 18 converts the rotary machine currents iᵤ, iᵥ, and i_{w} detected by the current detection unit 2 into an α-axis current i_{α} and a β-axis current i_{β} on the static biaxial coordinates. The second coordinate converter 17 converts the α-axis current i_{α} and the β-axis current i_{β} output from the three-phase to two-phase converter 18 into the d-axis current i_{d} and the q-axis current i_{q} on rotational coordinates that rotate in synchronization with the estimated value θ_{L} of the rotor position output from the position estimation unit 4, and outputs the d-axis current i_{d} and the q-axis current i_{q} to the subtractors 13d and 13q, respectively.

The first voltage commands Vᵤ*, Vᵥ*, and V_{w}* output from the two-phase to three-phase converter 16 and the high-frequency voltages Vᵤₕ, Vᵥₕ, and V_{wh} output from the position-estimating voltage generation unit 30 are added by the adders 23u, 23v, and 23w, respectively. Respective outputs of the adders 23u, 23v, and 23w are applied to the voltage applier 3 as the second voltage commands Vᵤₚ*, Vᵥₚ*, and V_{wp}*. Therefore, in the second voltage commands Vᵤₚ*, Vᵥₚ*, and V_{wp}* to be applied to the voltage applier 3, the high-frequency voltages Vᵤₕ, Vᵥₕ, and V_{wh} which are position-estimating voltage commands are superimposed on the first voltage commands Vᵤ*, Vᵥ*, and V_{w}*. Details of the high-frequency voltages Vᵤₕ, Vᵥₕ, and V_{wh} will be described later.

The position estimation unit 4 includes current extractors 6u, 6v, and 6w, a high-frequency current amplitude calculation unit 7, and a position calculator 8. As described above, in the second voltage commands Vᵤₚ*, Vᵥₚ*, and V_{wp}* to be applied to the voltage applier 3, the high-frequency voltages Vᵤₕ, Vᵥₕ, and V_{wh} output from the position-estimating voltage generation unit 30 are superimposed on the first voltage commands Vᵤ*, Vᵥ*, and V_{w}* output from the two-phase to three-phase converter 16. Therefore, the rotary machine currents iᵤ, iᵥ, and i_{w} detected by the current detection unit 2 include high-frequency currents iᵤₕ, iᵥₕ, and i_{wh} having the same frequency components as the high-frequency voltages Vᵤₕ, Vᵥₕ, and V_{wh}.

Therefore, the current extractors 6u, 6v, and 6w extract the high-frequency currents iᵤₕ, iᵥₕ, and i_{wh} having the same frequency components as the high-frequency voltages Vᵤₕ, Vᵥₕ, and V_{wh} from the rotary machine currents iᵤ, iᵥ, and i_{w} detected by the current detection unit 2. A band pass filter or a notch filter can be used to extract the high-frequency currents iᵤₕ, iᵥₕ, and i_{wh}. In a case where the notch filter is used, the rotary machine currents iᵤ, iᵥ, and i_{w} are input to the notch filter to attenuate the same frequency components as those in the high-frequency voltages Vᵤₕ, Vᵥₕ, and V_{wh}. Then, respective currents after passing through the notch filter are subtracted from the rotary machine currents iᵤ, iᵥ, and i_{w}, and thereby the high-frequency currents iᵤₕ, iᵥₕ, and i_{wh} can be extracted.

The high-frequency current amplitude calculation unit 7 includes multipliers 9u, 9v, and 9w, integrators 10u, 10v, and 10w, and square root calculators 22u, 22v, and 22w. These components are provided correspondingly to respective phases.

In the multipliers 9u, 9v, and 9w, autocorrelation values are obtained by squaring the high-frequency currents iᵤₕ, iᵥₕ, and i_{wh}. In each of the integrators 10u, 10v, and 10w, an integration process is performed at a time Tn of one integration period, and an integral value thereof is multiplied by (2/Tn) and a result thereof is output. In the square root calculators 22u, 22v, and 22w, square roots of respective outputs of the integrators 10u, 10v, and 10w are calculated, and thereby position-estimating current amplitudes Iᵤₕ, Iᵥₕ, and I_{wh} are obtained.

In the high-frequency current amplitude calculation unit 7 in FIG. 1, the position-estimating current amplitudes Iᵤₕ, Iᵥₕ, and I_{wh} are obtained by integrating the autocorrelation values of the high-frequency currents iᵤₕ, iᵥₕ, and i_{wh} and calculating the square roots thereof, but there is no limitation thereto. The position-estimating current amplitudes Iᵤₕ, Iᵥₕ, and I_{wh} may be obtained by passing the autocorrelation values of the high-frequency currents iᵤₕ, iᵥₕ, and i_{wh} through a low-pass filter.

The position calculator 8 calculates the estimated value θ_{L} of the rotor position on the basis of the position-estimating current amplitudes Iᵤₕ, Iᵥₕ, and I_{wh} calculated by the high-frequency current amplitude calculation unit 7. A known method is used to calculate the estimated value θ_{L} of the rotor position, and a detailed description thereof will be omitted here. Note that a specific calculation procedure is disclosed in, for example, Japanese Patent No. 5324646, and see the publication for reference.

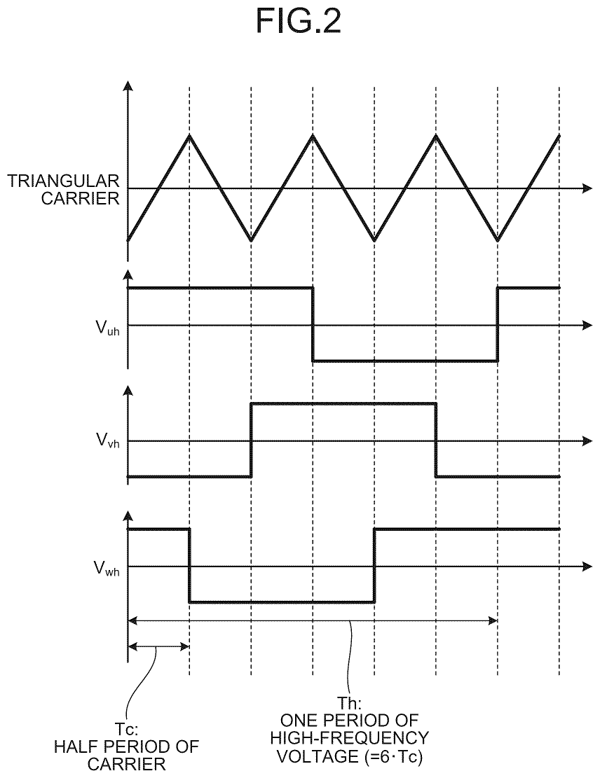

Next, the high-frequency voltages Vᵤₕ, Vᵥₕ, and V_{wh} output from the position-estimating voltage generation unit 30 will be described. FIG. 2 is a diagram illustrating examples of waveforms of the high-frequency voltages Vᵤₕ, Vᵥₕ, and V_{wh} output from the position-estimating voltage generation unit 30 in FIG. 1. Note that waveforms in FIG. 2 are examples in a case where the voltage applier 3 includes a triangular-wave-comparing pulse width modulation (PWM) inverter.

The horizontal axis in FIG. 2 represents time. In addition, FIG. 2 illustrates, from top to bottom, waveforms of a triangular carrier, the high-frequency voltage Vᵤₕ of the u phase, the high-frequency voltage Vᵥₕ of the v phase, and the high-frequency voltage V_{wh} of the w phase. When a half period Tc of the triangular carrier is defined as one section, one period Th of each of the high-frequency voltages Vᵤₕ, Vᵥₕ, and V_{wh} is a signal in which one period includes six sections (=6·Tc). In the examples in FIG. 2, the high-frequency voltages Vᵤₕ, Vᵥₕ, and V_{wh} are set to be shifted by two sections (=2·Tc) each between the respective phases in order to achieve three-phase equilibrium. Note that FIG. 2 illustrates examples, and there is no limitation to the examples. Any waveform may be used as long as the high-frequency voltages Vᵤₕ, Vᵥₕ, and V_{wh} have waveforms which are in three-phase equilibrium.

Returning to FIG. 1, the position-estimating voltage generation unit 30 will be described. The position-estimating voltage generation unit 30 includes a high-frequency amplitude calculator 31 and a high-frequency voltage generator 32. The high-frequency amplitude calculator 31 receives input of information on the q-axis current command i_{q}*. The high-frequency amplitude calculator 31 selects or calculates a coefficient value Wₕ on the basis of the q-axis current command i_{q}*. The coefficient value Wₕ is a positive real value set in order to determine voltage amplitudes of the high-frequency voltages Vᵤₕ, Vᵥₕ, and V_{wh}. A table in which the coefficient value Wₕ is stored can be used to select the coefficient value Wₕ. Alternatively, the coefficient value Wₕ may be calculated by function calculation without using the table.

In addition, the q-axis current command i_{q}* is an example of a physical quantity correlated with magnetic saturation of the rotor 1b. Any physical quantity other than the q-axis current command i_{q}* may be used as long as the physical quantity is correlated with the magnetic saturation of the rotor 1b. Other examples of the physical quantity correlated with the magnetic saturation of the rotor 1b include the q-axis current i_{q} and the q-axis voltage command V_{q}*. The d-axis current command i_{d}*, the d-axis current i_{d}, the d-axis voltage command V_{d}*, and the like can also be physical quantities correlated with the magnetic saturation of the rotor 1b.

The high-frequency voltage generator 32 generates the high-frequency voltages Vᵤₕ, Vᵥₕ, and V_{wh} described above by using the coefficient value Wₕ. An operation of the high-frequency voltage generator 32 will be described by using the following several formulae.

In describing the operation of the high-frequency voltage generator 32, a formula representing a high-frequency current will be derived. First, a voltage equation of the rotary machine 1 on αβ axes which are static coordinates is expressed by the following formula (1).

$$\begin{matrix}Formula 1 & \\ [ \begin{matrix}{V}_{α} \\ {V}_{β}\end{matrix} ] = [ \begin{matrix}R + {pL}_{α} & {pL}_{αβ} \\ {pL}_{αβ} & R + {pL}_{β}\end{matrix} ] [ \begin{matrix}{i}_{α} \\ {i}_{β}\end{matrix} ] + ω {K}_{E} [ \begin{matrix}- sin θ \\ cos θ\end{matrix} ] & ( 1 )\end{matrix}$$

$${L}_{α} = {L}_{0} + {L}_{1} cos ( 2 θ )$$

$${L}_{β} = {L}_{0} - {L}_{1} cos ( 2 θ )$$

$${L}_{αβ} = {L}_{1} sin ( 2 θ )$$

$${L}_{0} = \frac{{L}_{d} + {L}_{q}}{2}$$

$${L}_{1} = \frac{{L}_{d} - {L}_{q}}{2}$$

In the above formula (1), i_{α} and is are the α-axis current and the β-axis current described above. V_{α} and V_{β} represent an α-axis voltage and a β-axis voltage, respectively. R and K_{E} represent a stator resistance and an induced voltage coefficient, respectively. L_{α}, L_{β}, L_{αβ}, L_{d}, and L_{q} represent an α-axis inductance, a β-axis inductance, a mutual inductance between the αβ axes, a d-axis inductance, and a q-axis inductance, respectively. L₀ is defined by a fifth formula of the above formula (1), and L₁ is defined by a sixth formula of the above formula (1). p means a differential operator.

The above formula (1) is applicable in a case where the rotary machine 1 is a reluctance synchronous machine. In a case where the rotary machine 1 is a reluctance synchronous machine including no magnet, the induced voltage coefficient K_{E} in the above formula (1) is zero, so that a second term of the above formula (1) including the induced voltage coefficient K_{E} can be omitted. In addition, when considering only high-frequency components in the above formula (1), the following formula (2) is obtained.

$$\begin{matrix}Formula 2 & \\ [ \begin{matrix}{V}_{α h} \\ {V}_{β h}\end{matrix} ] = p [ \begin{matrix}{L}_{α} & {L}_{αβ} \\ {L}_{αβ} & {L}_{β}\end{matrix} ] [ \begin{matrix}{i}_{α h} \\ {i}_{β h}\end{matrix} ] & ( 2 )\end{matrix}$$

In the above formula (2), V_{αh}, V_{βh}, i_{αh}, and i_{βh} represent high-frequency components of the α-axis voltage, the β-axis voltage, the α-axis current, and the β-axis current, respectively. Note that, regarding the transformation from the above formula (1) to the above formula (2), a similar formula can be obtained in a synchronous reluctance motor that does not use a magnet. Therefore, needless to say, the above formula (2) is not limited to an interior permanent magnet rotary machine.

When the above formula (2) is solved for a current derivative term, the following formula (3) is obtained.

$$\begin{matrix}Formula 3 & \\ p [ \begin{matrix}{i}_{α h} \\ {i}_{β h}\end{matrix} ] = \frac{1}{{L}_{0}^{2} - {L}_{1}^{2}} \{ {L}_{0} I - {L}_{1} [ \begin{matrix}cos ( 2 θ ) & sin ( 2 θ ) \\ sin ( 2 θ ) & - cos ( 2 θ )\end{matrix} ] \} [ \begin{matrix}{V}_{α h} \\ {V}_{β h}\end{matrix} ] & ( 3 )\end{matrix}$$

High-frequency voltages V_{α} and V_{β} on the αβ axes are defined by the following formula (4).

$$\begin{matrix}Formula 4 & \\ [ \begin{matrix}{V}_{α h} \\ {V}_{β h}\end{matrix} ] = {V}_{h αβ} [ \begin{matrix}cos ( {ω}_{h} t ) \\ sin ( {ω}_{h} t )\end{matrix} ] & ( 4 )\end{matrix}$$

In the above formula (4), V_{hαβ} represents a high-frequency voltage amplitude on the αβ axes, and ωₕ represents an angular frequency on the αβ axes. The angular frequency is also called an “angular velocity”.

When the above formula (4) is expressed on three-phase coordinates, default high-frequency voltages Vᵤₕ₁, Vᵥₕ₁, and V_{wh1} expressed by the following formula (5) are obtained.

$$\begin{matrix}Formula 5 & \\ [ \begin{matrix}{V}_{uh 1} \\ {V}_{vh 1} \\ {V}_{wh 1}\end{matrix} ] = {V}_{huvw} [ \begin{matrix}sin ( {ω}_{h} t ) \\ sin ( {ω}_{h} t - 2 π / 3 ) \\ sin ( {ω}_{h} t + 2 π / 3 )\end{matrix} ] & ( 5 )\end{matrix}$$

With the use of the coefficient value Wₕ calculated by the high-frequency amplitude calculator 31, the high-frequency voltage generator 32 multiplies the default high-frequency voltages Vᵤₕ₁, Vᵥₕ₁, and V_{wh1} by the coefficient value Wₕ, thereby generating the high-frequency voltages Vᵤₕ, Vᵥₕ, and V_{wh} expressed by the following formula (6).

$$\begin{matrix}Formula 6 & \\ [ \begin{matrix}{V}_{uh} \\ {V}_{vh} \\ {V}_{wh}\end{matrix} ] = {W}_{h} [ \begin{matrix}{V}_{uh 1} \\ {V}_{vh 1} \\ {V}_{wh 1}\end{matrix} ] & ( 6 )\end{matrix}$$

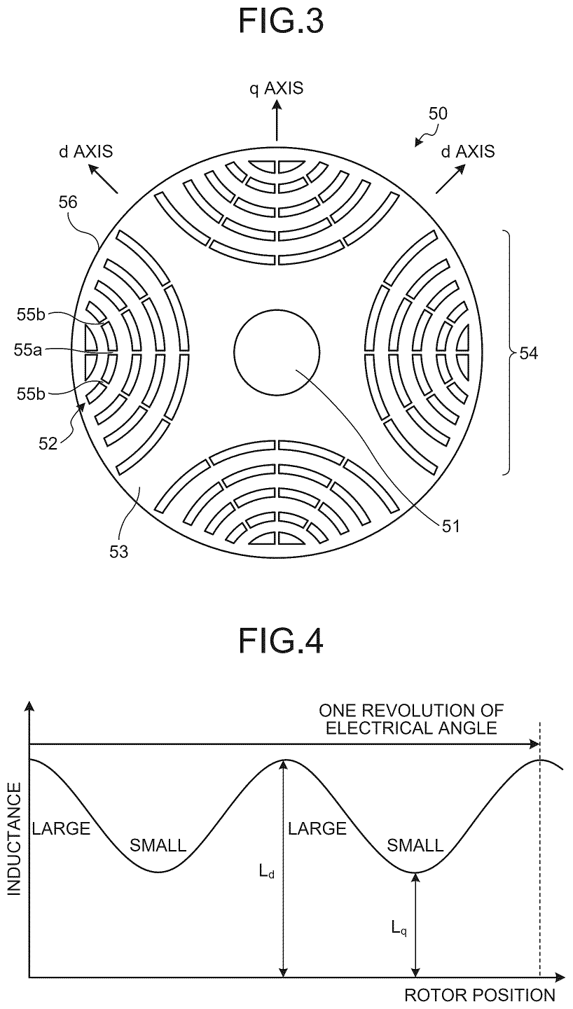

Next, a structure of a rotor core constituting the rotor 1b in a reluctance synchronous machine will be described. FIG. 3 is a cross-sectional view used for explanation of a structure of a rotor core 50 in the reluctance rotary machine assumed in the first embodiment. In FIG. 3, the rotor core 50 is constituted by laminating a plurality of electromagnetic steel sheets which are sheet materials. A shaft 51 is fitted in the rotor core 50 on a radially inward side thereof. The rotor core 50 is formed of a laminate obtained by laminating a core segment 53 which is an annular thin sheet. The core segment 53 can be formed by punching an electromagnetic steel sheet which is a thin steel sheet with a pressing machine. In the rotary machine 1 that has been assembled, a laminating direction of the thin sheets constituting the rotor core 50 is the same as an axial direction of the shaft 51.

A plurality of slits 52 that form a flux barrier are formed in the rotor core 50 in which the plurality of core segments 53 are laminated. The slits 52 have an arc shape protruding toward a shaft hole in which the shaft 51 is fitted, and are formed from a side of one d axis to a side of another d axis with the q axis as the center. In the rotor core 50, the d axis is an axis which is relatively easy for a magnetic flux to pass through, and the q axis is an axis which is relatively difficult for a magnetic flux to pass through. The d axis and the q axis are magnetically and electrically orthogonal to each other.

Slit groups 54 each including the plurality of slits 52 are formed, for the number of poles, at intervals in a circumferential direction of the rotor core 50. FIG. 3 illustrates an example in which the rotor 1b includes four poles, and in FIG. 3, the slit groups 54 for four poles are formed.

The rotor core 50 needs to be strong enough to withstand a centrifugal force when the rotary machine 1 rotates. Therefore, a center rib 55a acting as a strength member is formed in the slit 52 located at an outermost periphery. In addition to the center rib 55a, two side ribs 55b similarly acting as strength members are formed in each of the slits 52 located at a portion other than the outermost periphery. The center ribs 55a and the side ribs 55b can be formed by leaving portions corresponding to the center ribs 55a and the side ribs 55b unpunched when punching a thin steel sheet to form the slits 52. The dispositions of the center ribs 55a and the side ribs 55b illustrated in FIG. 3 are examples, and there is no limitation to these dispositions. Any disposition may be employed as long as desired strength can be obtained by the structure.

In addition, in the rotor core 50, an annular-shaped portion where no slit is formed is present between each slit group 54 and an edge portion 56 on an outer peripheral side of the rotor core 50. In this description, this portion is referred to as an “annular portion”. In the rotor core 50, the annular portion also acts as a strength member. In this description, the strength members such as the center ribs 55a, the side ribs 55b, and the annular portion which act as the strength members may be collectively referred to as “bridge portions”.

The fifth and sixth formulae of the above formula (1) include the d-axis inductance L_{d} and the q-axis inductance L_{q}. FIG. 4 is a diagram illustrating a change in inductance in a general reluctance rotary machine. The horizontal axis represents the rotor position, and the vertical axis represents the magnitude of inductance.

In a general reluctance rotary machine, inductance changes depending on an electrical angle. Specifically, as illustrated in FIG. 4, there is a characteristic in which a maximum value and a minimum value of the inductance each appear twice per revolution of the electrical angle. The maximum value of the inductance is the d-axis inductance L_{d}, and the minimum value of the inductance is the q-axis inductance L_{q}. That is, the d-axis inductance La is larger than the q-axis inductance L_{q}. Here, when a ratio of the q-axis inductance L_{q} to the d-axis inductance L_{d} is defined as a saliency ratio, a saliency ratio L_{q}/L_{d} is a value larger than 1. This is because the rotary machine 1 is configured so that a magnetic flux linkage by the q-axis current i_{q} is larger than a magnetic flux linkage by the d-axis current i_{d} in the currents flowing through the rotary machine 1.

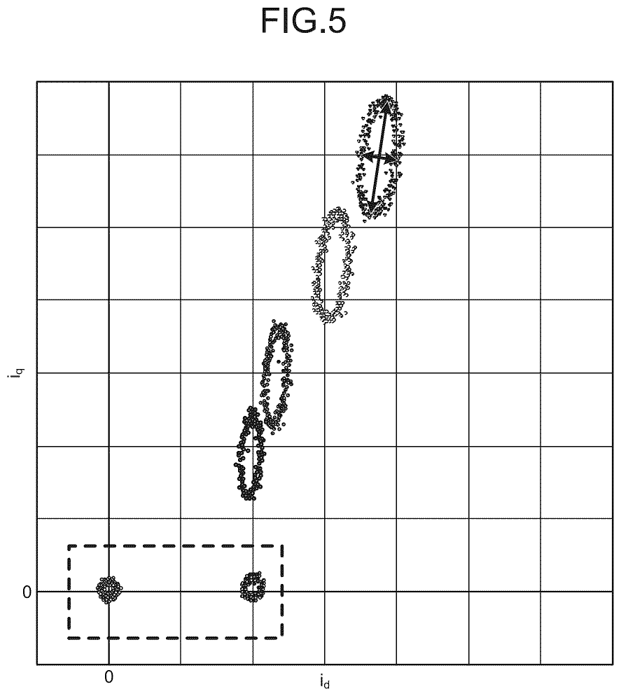

FIG. 5 is a diagram illustrating examples of current vector loci when a high-frequency current is flowed through a rotary machine including the rotor core 50 illustrated in FIG. 3. In FIG. 5, the horizontal axis represents the d-axis current i_{d}, and the vertical axis represents the q-axis current i_{q}. As illustrated in FIG. 5, in a case where the q-axis current i_{q} flowing through the rotary machine 1 is relatively large, current vector loci have an elliptical shape. On the other hand, in a case where the q-axis current i_{q} flowing through the rotary machine 1 is small, as illustrated in the lower left, the current vector loci do not have an elliptical shape but have a substantially circular shape. The center of each current vector locus represents a component of a fundamental current in the currents flowing through the rotary machine 1, and a distance from the center in each of plots of the current vector loci represents a component of a high-frequency current in the currents flowing through the rotary machine 1. Therefore, a region where the q-axis current i_{q} is small means that a torque command to be given to the rotary machine 1 is small.

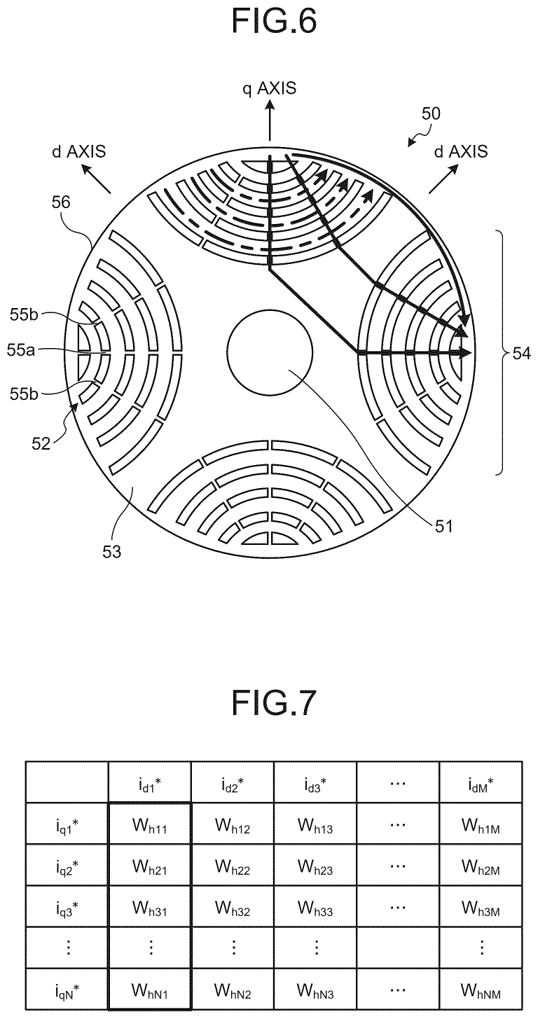

In a case where a current vector locus has an elliptical shape, the rotor position can be detected from a direction of a major axis and a direction of a minor axis of the ellipse. On the other hand, in a case where the current vector locus does not have an elliptical shape, it is difficult to distinguish between the major axis and the minor axis, so that the rotor position cannot be accurately detected. A reason therefor will be described with reference to FIG. 6. FIG. 6 is a diagram illustrating, in the rotor core 50 illustrated in FIG. 3, a flow of a magnetic flux generated by a component of a high-frequency current when a component of a fundamental current is small.

In FIG. 6, solid arrow lines each indicate a flow of a magnetic flux that can be generated by a component of a high-frequency current included in the q-axis current i_{q}. In this description, this magnetic flux component is referred to as a “torque magnetic flux” for convenience. Broken arrow lines each indicate a flow of a magnetic flux that can be generated by a component of a high-frequency current included in the d-axis current i_{d}. In this description, this magnetic flux component is referred to as an “excitation magnetic flux” for convenience. As described above, the rotor core 50 illustrated in FIG. 3 has a structure with saliency. Therefore, during a steady operation in which a component of the fundamental current is large, the bridge portion of the rotor core 50 is magnetically saturated sufficiently, so that a q-axis magnetic flux indicated by a solid arrow becomes small. On the other hand, in a case where the component of the fundamental current is small, the degree of magnetic saturation in the bridge portion is low, so that the torque magnetic flux passing through the bridge portion does not attenuate very much. Therefore, the torque magnetic flux passing through the bridge portion increases, a difference from the excitation magnetic flux decreases, and thus the saliency does not appear.

The control device 100 according to the first embodiment illustrated in FIG. 1 described above is configured so that the above-described problem regarding saliency is solved. Specifically, in a case where desired detection accuracy cannot be obtained with respect to the estimated value θ_{L} of the rotor position, the control device 100 controls the coefficient value Wₕ calculated by the high-frequency amplitude calculator 31 in such a direction so as to increase the coefficient value, and performs control to increase the voltage amplitudes of the high-frequency voltages Vᵤₕ, Vᵥₕ, and V_{wh}. In this description, this control is referred to as “high-frequency boost control” for convenience.

Here, considering a case where there is no high-frequency current, in a case where the fundamental current is small, a magnetic flux component thereof easily passes through the bridge portion. When the width of the bridge portion is narrowed, the amount of the magnetic flux passing therethrough decreases, but the strength of the rotor core 50 decreases. When the fundamental current is increased, a portion where the bridge portion is present is magnetically saturated. However, in a case of this method, an unnecessary current is caused to flow, which deteriorates the efficiency, and in addition, an unnecessary torque is provided to the rotary machine 1, which is not preferable in terms of operation. On the other hand, when the high-frequency current is increased, the bridge portion can be magnetically saturated without changing the magnitude of the fundamental current. Consequently, it is possible to overcome, by control, the property that the fundamental current hinders the saliency from appearing.

The specific processes are as described above. The coefficient value Wₕ is calculated by the high-frequency amplitude calculator 31, and the default high-frequency voltages Vᵤₕ₁, Vᵥₕ₁, and V_{wh1} are multiplied by the coefficient value Wₕ, and thereby the high-frequency voltages Vᵤₕ, Vᵥₕ, and V_{wh} are generated. In addition, a table can be used to calculate the coefficient value Wₕ. FIG. 7 is a diagram illustrating an example of a coefficient value table used in the high-frequency boost control according to the first embodiment.

FIG. 7 illustrates, at the top of the coefficient value table, current values i_{d1}*, i_{d2}*, i_{d3}*, . . . , and i_{dM}* of the d-axis current command i_{d}* that can be set, and illustrates, at the front side of the coefficient value table, current values i_{q1}*, i_{q2}*, i_{q3}*, . . . , and i_{qN}* of the q-axis current command i_{q}* that can be set. Increments that are intervals between the current values i_{d1}*, i_{d2}*, i_{d3}*, . . . , and i_{dM}* do not need to be equal intervals, and may be unequal intervals. The same applies to the current values i_{q1}*, i_{q2}*, i_{q3}*, . . . , and i_{qN}*.

The coefficient value table stores values (Wₕ₁₁, Wₕ₁₂, Wₕ₁₃, . . . , W_{h1M}, Wₕ₂₁, Wₕ₂₂, Wₕ₂₃, . . . , W_{h2M}, Wₕ₃₁, Wₕ₃₂, Wₕ₃₃, . . . , W_{h3M}, . . . , W_{hN1}, W_{hN2}, W_{hN3}, . . . , and W_{hNM}) of the coefficient value Wₕ determined by the relationship between the d-axis current command i_{d}* and the q-axis current command i_{q}*. Note that in a case where the current values i_{q1}*, i_{q2}*, i_{q3}*, . . . , and i_{qN}* satisfy a relationship of i_{q1}*<i_{q2}*<i_{q3}*<, . . . <i_{qN}*, a relationship of Wₕ₁₁>Wₕ₂₁>Wₕ₃₁>, . . . , >W_{hN1} is satisfied by Wₕ₁₁, Wₕ₂₁, Wₕ₃₁, . . . , and W_{hN1}. That is, the coefficient value Wₕ has a negative correlation with the q-axis current command i_{q}*. The same applies to the coefficient values Wₕ of other columns. In addition, in a case where the current values i_{d1}*, i_{d2}*, i_{d3}*, . . . , and i_{dM}* satisfy a relationship of i_{d1}*<i_{d2}*<i_{d3}*<, . . . , <i_{dM}*, a relationship of Wₕ₁₁>Wₕ₂₁>Wₕ₃₁>, . . . , >W_{h1M} is satisfied by Wₕ₁₁, Wₕ₁₂, Wₕ₁₃, . . . , and W_{h1M}. That is, the coefficient value Wₕ has a negative correlation with the d-axis current command i_{d}*. The same applies to the coefficient values Wₕ of other rows.

The stored values stored in the coefficient value table can be obtained by simulation. Note that all the stored values do not need to be obtained by simulation, and the stored values may be obtained by an arithmetic process by an interpolation process, an extrapolation process, or an interpolation process of some simulation results.

Next, selection of the coefficient value Wₕ in the high-frequency boost control according to the first embodiment will be described. First, in the coefficient value table in FIG. 7, a portion surrounded by a thick frame is set as a default. Here, i_{d1}*=0 is assumed. The high-frequency amplitude calculator 31 selects the coefficient value Wₕ with reference to the thick frame portion of the coefficient value table in FIG. 7 on the basis of the q-axis current command i_{q}*. For example, when a value of the q-axis current command i_{q}* is “i_{q3}*”, “Wₕ₃₁” is selected. In a case where a value of the q-axis current command i_{q}* is a value between “i_{q2}*” and “i_{q3}*”, the value may be obtained by the interpolation process, or any one of “i_{q2}*” and “i_{q3}*” may be selected.

In addition to the q-axis current command i_{q}*, the d-axis current command i_{d}* may be used as a physical quantity correlated with the magnetic saturation of the rotor 1b. In that case, the entirety of the coefficient value table in FIG. 7 is used. For example, when a value of the q-axis current command i_{q}* is “i_{q3}*” and a value of the d-axis current command i_{d}* is “i_{d2}*”, “Wₕ₃₂” is selected. It is needless to say that the value may be obtained by the interpolation process or the like when the value is not in the coefficient value table.

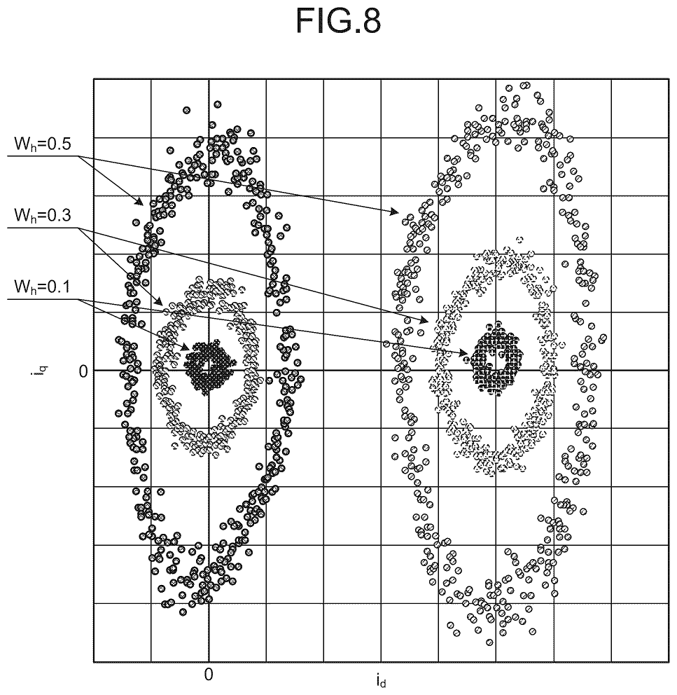

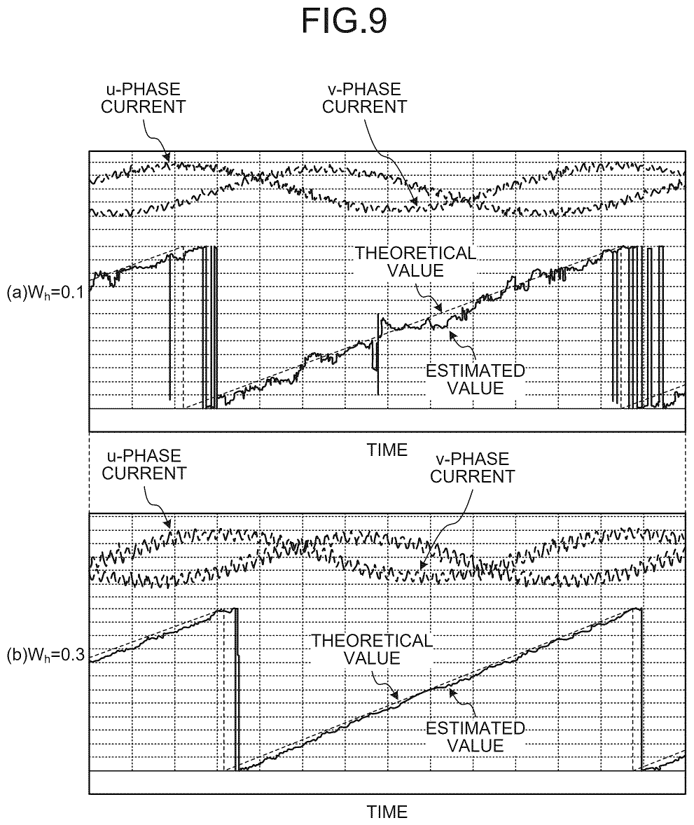

Next, an effect of the high-frequency boost control according to the first embodiment will be described with reference to FIGS. 8 and 9. FIG. 8 is a first diagram for explaining an effect of the high-frequency boost control according to the first embodiment. FIG. 9 is a second diagram for explaining the effect of the high-frequency boost control according to the first embodiment.

In FIG. 8, the horizontal axis represents the d-axis current i_{d}, and the vertical axis represents the q-axis current i_{q}. On the left side of FIG. 8, cases where the coefficient values Wₕ satisfy Wₕ=0.1, Wₕ=0.3, and Wₕ=0.5 are illustrated as current vector loci when the q-axis current i_{q}=0 and the d-axis current i_{d}=0. On the right side of FIG. 8, current vector loci when the q-axis current i_{q}=0 and the d-axis current i_{d}>0 are illustrated for the same three coefficient values Wₕ as above. The coefficient values Wₕ can be determined by using the direct-current voltage V_{dc} of the direct-current power supply 12 as reference. Note that the reference of the coefficient values Wₕ is not limited to this example, and the coefficient values Wₕ may be determined on the basis of any reference.

In FIG. 9, a theoretical value of the rotor position is indicated by a broken line, and the estimated value θ_{L} of the rotor position is indicated by a solid line, together with waveforms of a u-phase current and a v-phase current. (a) on an upper stage is a waveform when Wₕ=0.1, and (b) on a lower stage is a waveform when Wₕ=0.3.

According to FIG. 8, when Wₕ=0.1, the current vector locus does not have an elliptical shape, whereas when Wₕ=0.3 and Wₕ=0.5, the current vector loci each have an elliptical shape. It is also illustrated that this tendency does not depend on the d-axis current i_{d}.

The above results are consistent with the above description. For example, when Wₕ=0.1, since the portions of the center ribs 55a and the side ribs 55b of the rotor core 50 are not magnetically saturated, the torque magnetic flux passing through the center ribs 55a and the side ribs 55b increases, which hinders the saliency from appearing. Consequently, the current vector locus does not have an elliptical shape. Consequently, as illustrated in (a) of FIG. 9, the waveform of the estimated value θ_{L} of the rotor position becomes unstable, and sufficient estimation accuracy cannot be obtained.

On the other hand, when Wₕ=0.3 and Wₕ=0.5, the portions of the center ribs 55a and the side ribs 55b of the rotor core 50 are magnetically saturated by the high-frequency current, and thus the torque magnetic flux passing through the center ribs 55a and the side ribs 55b decreases and the saliency appears, so that the current vector loci each have an elliptical shape. Consequently, as illustrated in (b) of FIG. 9, the waveform of the estimated value θ_{L} of the rotor position becomes stable, and sufficient estimation accuracy can be obtained.

The control and the operation thereof when the high-frequency boost control according to the first embodiment is applied to the rotor core 50 having the structure illustrated in FIG. 6 have been described above, but there is no limitation to this example, and application can be made to rotor cores having various structures. The high-frequency boost control according to the first embodiment can also be applied to a rotor core having an extremely small saliency ratio. For example, in a case where the saliency ratio of the rotor core is small, by selecting a larger coefficient value Wₕ depending on the degree of the smallness and setting the high-frequency voltage amplitude, the rotor position can be detected.

However, increasing the coefficient value Wₕ means increasing the rotary machine current. Therefore, there is a trade-off relationship between operation efficiency of the rotary machine 1 and estimation accuracy of the estimated value θ_{L}. Therefore, it is desirable to select the coefficient value Wₕ as small as possible within a range that satisfies the estimation accuracy of the estimated value θ_{L}. For example, regarding the example in FIG. 8, it is desirable to select Wₕ=0.3. Use of a table as illustrated in FIG. 7 makes it possible to select such a coefficient value Wₕ.

As described above, according to the rotary machine control device of the first embodiment, the current control unit generates the first voltage commands which are command values of the rotary machine voltages for driving the rotary machine on the basis of the detected values of the rotary machine currents and the estimated value of the rotor position. Then, the position-estimating voltage generation unit generates the high-frequency voltages having frequencies higher than the first voltage commands, the high-frequency voltages being position-estimating voltages for estimating the rotor position, on the basis of the physical quantity correlated with the magnetic saturation of the rotor. Consequently, it is possible to reduce a decrease in detection accuracy of the rotor position even in a case where the saliency ratio of the rotary machine is structurally small.

In addition, in the above configuration, the position-estimating voltage generation unit includes the high-frequency amplitude calculator that calculates a coefficient value for determining voltage amplitudes of high-frequency voltages on the basis of a physical quantity correlated with magnetic saturation. The high-frequency amplitude calculator generates the position-estimating voltages by using the coefficient value. Consequently, the configuration of the control device can be easily realized.

In the above description, the physical quantity correlated with the magnetic saturation of the rotor may be a torque-axis current command given to the current control unit, or may be the torque-axis current command and an excitation-axis current command given to the current control unit. Since the torque-axis current command and the excitation-axis current command are parameters used inside the control device, the configuration of the control device can be more easily realized.

According to the rotary machine control device of the first embodiment, in a case where desired detection accuracy cannot be obtained with respect to the estimated value of the rotor position, the coefficient value for determining the voltage amplitudes is controlled in such a direction so as to increase the coefficient value. Consequently, it is possible to set a coefficient value corresponding to desired detection accuracy while reducing an increase in a high-frequency current.

According to the rotary machine control device of the first embodiment, the rotor position can be detected even when the torque-axis current and the excitation-axis current are zero. Consequently, it is possible to stably estimate the rotor position while increasing the operation efficiency of the rotary machine.

### Second Embodiment

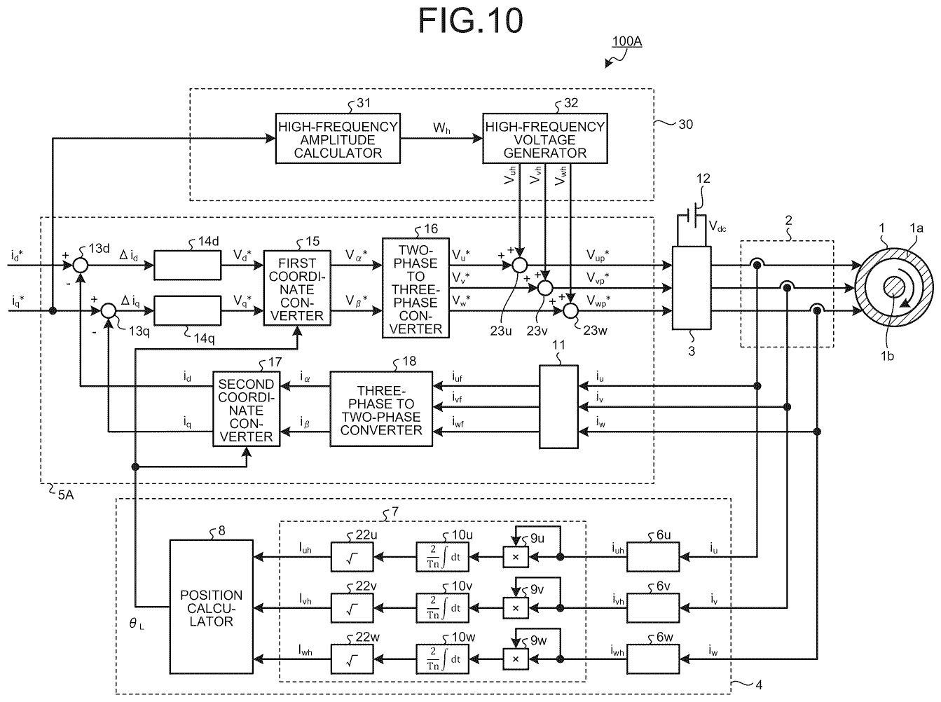

FIG. 10 is a diagram illustrating an exemplary configuration of a rotary machine control device 100A according to a second embodiment. Comparing the control device 100A according to the second embodiment with the control device 100 illustrated in FIG. 1, the current control unit 5 is replaced with a current control unit 5A in FIG. 10. In the current control unit 5A, a fundamental current extractor 11 is added to the configuration of the current control unit 5 illustrated in FIG. 1. Other configurations are the same as or equivalent to those of the control device 100. The same or equivalent components are denoted by the same reference numerals, and redundant descriptions thereof will not be repeated.

As described above, since the high-frequency current including a superimposed frequency component and a sideband component is a disturbance for a current control system, it is desirable that the high-frequency current be sufficiently separated from a response frequency of the current control system. On the other hand, for the purpose of ensuring calculation time and reducing noise, the superimposed frequency may be set to a lower frequency, and the response frequency and the superimposed frequency of the current control system may be set closer to each other, which has an adverse effect on processes of the current control system. In addition, as described above, in an application in which the rotation speed of the rotary machine is high, the sideband component is distributed in a wide area, which has an adverse effect on the processes of the current control system.

Therefore, in the second embodiment, the fundamental current extractor 11 is provided in order to remove or reduce the effect of the high-frequency currents generated by the application of the high-frequency voltages Vᵤₕ, Vᵥₕ, and V_{wh}. As illustrated in FIG. 10, the fundamental current extractor 11 is disposed between the current detection unit 2 and the three-phase to two-phase converter 18, that is, at a preceding stage of the three-phase to two-phase converter 18.

The fundamental current extractor 11 extracts fundamental currents i_{uf}, i_{vf}, and i_{wf} obtained by removing or attenuating, from or in the rotary machine currents iᵤ, iᵥ, and i_{w} detected by the current detection unit 2, the same frequency components as those of the high-frequency voltages Vᵤₕ, Vᵥₕ, and V_{wh}. A low-pass filter or a notch filter can be used to extract the fundamental currents i_{uf}, i_{vf}, and i_{wf}. The three-phase to two-phase converter 18 performs the process described in the first embodiment by using the fundamental currents i_{uf}, i_{vf}, and i_{wf} as input signals. The subsequent processes are as described in the first embodiment.

According to the control device 100A of the second embodiment, in a process performed by the current control unit 5A which is a current control system, the superimposed frequency component and the sideband component thereof in the high-frequency currents iᵤₕ, iᵥₕ, and i_{wh} are sufficiently removed from the rotary machine currents iᵤ, iᵥ, and i_{w} detected by the current detection unit 2. Consequently, it is possible to prevent an adverse effect on the current control system such as deterioration in response or instability.

As described above, according to the rotary machine control device of the second embodiment, the fundamental component extractor removes harmonic superimposed components included in detected values of the rotary machine currents to extract fundamental components. Then, the current control unit generates the first voltage commands on the basis of outputs of the fundamental component extractor and the estimated value of the rotor position. Consequently, an effect is obtained that it is possible to reliably prevent an adverse effect on the current control system such as deterioration in response or instability.

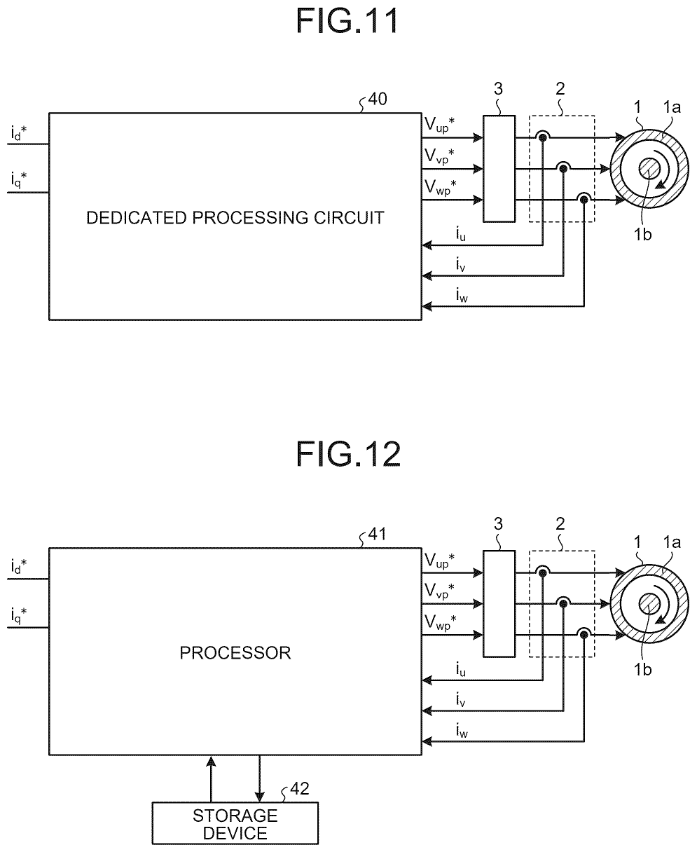

Next, a hardware configuration of the control devices 100 and 100A according to the first embodiment and second embodiment described above will be described with reference to FIGS. 11 and 12. FIG. 11 is a diagram illustrating a first exemplary hardware configuration that realizes functions of the control devices 100 and 100A according to the first embodiment and the second embodiment. FIG. 12 is a diagram illustrating a second exemplary hardware configuration that realizes the functions of the control devices 100 and 100A according to the first embodiment and the second embodiment. The functions of the control devices 100 and 100A refer to functions of the position estimation unit 4, the current control units 5 and 5A, and the position-estimating voltage generation unit 30 included in the control devices 100 and 100A.

The functions of the position estimation unit 4, the current control units 5 and 5A, and the position-estimating voltage generation unit 30 can be realized by using a processing circuitry. In FIG. 11, the position estimation unit 4, the current control units 5 and 5A, and the position-estimating voltage generation unit 30 in the first embodiment and the second embodiment are replaced with a dedicated processing circuit 40. In a case where dedicated hardware is used, the dedicated processing circuit 40 corresponds to a single circuit, a composite circuit, an application specific integrated circuit (ASIC), a field programmable gate array (FPGA), or a combination thereof. The functions of the position estimation unit 4, the current control units 5 and 5A, and the position-estimating voltage generation unit 30 may be each realized by the processing circuitry, or may be collectively realized by the processing circuitry.

In FIG. 12, the position estimation unit 4, the current control units 5 and 5A, and the position-estimating voltage generation unit 30 in the configurations of the first embodiment and the second embodiment are replaced with a processor 41 and a storage device 42. The processor 41 may be an arithmetic means such as an arithmetic device, a microprocessor, a microcomputer, a central processing unit (CPU), or a digital signal processor (DSP). As the storage device 42, a nonvolatile or volatile semiconductor memory such as a random access memory (RAM), a read only memory (ROM), a flash memory, an erasable programmable ROM (EPROM), or an electrically EPROM (EEPROM) (registered trademark) can be exemplified.

In a case where the processor 41 and the storage device 42 are used, the functions of the position estimation unit 4, the current control units 5 and 5A, and the position-estimating voltage generation unit 30 are realized by software, firmware, or a combination thereof. The software or the firmware is described as a program and stored in the storage device 42. The processor 41 reads and executes programs stored in the storage device 42. It can also be said that these programs cause a computer to execute procedures and methods of the functions of the position estimation unit 4, the current control units 5 and 5A, and the position-estimating voltage generation unit 30. As the storage device 42, for example, a nonvolatile or volatile semiconductor memory such as ROM, EPROM, or EEPROM, a flexible disk, an optical disk, a compact disc, or DVD can be used.

A part of the functions of the position estimation unit 4, the current control units 5 and 5A, and the position-estimating voltage generation unit 30 may be realized by hardware, and another part thereof may be realized by software or firmware. For example, the function of the position-estimating voltage generation unit 30 may be realized by using dedicated hardware, and the functions of the position estimation unit 4 and the current control units 5 and 5A may be realized by using the processor 41 and the storage device 42.

The configurations described in the above embodiments are merely examples and can be combined with other known technology, the embodiments can be combined with each other, and part of the configurations can be omitted or modified without departing from the gist thereof.

### REFERENCE SIGNS LIST

1 rotary machine; 1a stator; 1b rotor; 2 current detection unit; 3 voltage applier; 4 position estimation unit; 5, 5A current control unit; 6u, 6v, 6w current extractor; 7 high-frequency current amplitude calculation unit; 8 position calculator; 9u, 9v, 9w multiplier; 10u, 10v, 10w integrator; 11 fundamental current extractor; 12 direct-current power supply; 13d, 13q subtractor; 14d d-axis current controller; 14q q-axis current controller; 15 first coordinate converter; 16 two-phase to three-phase converter; 17 second coordinate converter; 18 three-phase to two-phase converter; 22u, 22v, 22w square root calculator; 23u, 23v, 23w adder; 30 position-estimating voltage generation unit; 31 high-frequency amplitude calculator; 32 high-frequency voltage generator; 40 dedicated processing circuit; 41 processor; 42 storage device; 50 rotor core; 51 shaft; 52 slit; 53 core segment; 54 slit group; 55a center rib; 55b side rib; 56 edge portion; 100, 100A control device.

1. A rotary machine control device comprising:
a current detector to detect a rotary machine current flowing through a rotary machine;
a position estimator to calculate an estimated value of a rotor position that is position information of a rotor of the rotary machine on a basis of the rotary machine current;
a current controller to generate a first voltage command that is a command value of a rotary machine voltage for driving the rotary machine on a basis of a detected value of the rotary machine current and an estimated value of the rotor position;
a position-estimating voltage generator to generate a high-frequency voltage having a frequency higher than the first voltage command, the high-frequency voltage being a position-estimating voltage for estimating the rotor position, on a basis of a physical quantity correlated with magnetic saturation of the rotor; and
a voltage applier to apply a driving voltage to the rotary machine on a basis of a second voltage command in which the position-estimating voltage is superimposed on the first voltage command.

2. The rotary machine control device according to claim 1, wherein
the physical quantity is a torque-axis current command given to the current controller.

3. The rotary machine control device according to claim 1, wherein
the physical quantity is a torque-axis current command and an excitation-axis current command given to the current controller.

4. The rotary machine control device according to claim 1, wherein
the position-estimating voltage generator
includes a high-frequency amplitude calculator to calculate a coefficient value for determining a voltage amplitude of the high-frequency voltage on a basis of the physical quantity, and
generates the position-estimating voltage by using the coefficient value.

5. The rotary machine control device according to claim 4, wherein
the coefficient value has a negative correlation with the physical quantity.

6. The rotary machine control device according to claim 4, wherein
in a case where desired detection accuracy is not obtainable with respect to an estimated value of the rotor position, the coefficient value is controlled in such a direction so as to increase the coefficient value.

7. The rotary machine control device according to claim 1, wherein
the current controller includes a fundamental component extractor to remove a harmonic superimposed component included in a detected value of the rotary machine current to extract a fundamental component, and
generates the first voltage command on a basis of output of the fundamental component extractor and an estimated value of the rotor position.
